(19) United States
(12) Patent Application Publication
(10) Pub. No.: US 2009/0319547 A1
(43) Pub. Date: Dec. 24, 2009

(54) Compression Using Hashes

(75) Inventor: William K. Hollis, Duvall, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/142,760

(22) Filed: Jun. 19, 2008

(51) Int. Cl. G06F 17/30

(52) U.S. Cl. 707/101; 707/E17.002

(57) ABSTRACT

A compression algorithm may use a hash function to compress a file. The hash function may be selected to have multiple collisions so that a compressed file may include the hash values and indexes to the collisions. In some cases, a database of data and their hash values may be built during compression, while in other cases a preexisting database may be used. A preexisting database may be used as a shared secret to provide security to the compressed file. In many embodiments, the compression algorithm may be used recursively to reduce the size of the file by using the same or different hash functions.

### BACKGROUND

Compression techniques may be used to reduce the size of data in a file or set of files. In many cases, lossless compression techniques may be used to reduce the size of a file so that the file is easier to transmit and store. The file may be uncompressed or expanded into its original state. Some compression techniques may be used with encryption techniques so that the file is difficult to read in the compressed state.

### SUMMARY

A compression algorithm may use a hash function to compress a file. The hash function may be selected to have multiple collisions so that a compressed file may include the hash values and indexes to the collisions. In some cases, a database of data and their hash values may be built during compression, while in other cases a preexisting database may be used. A preexisting database may be used as a shared secret to provide security to the compressed file. In many embodiments, the compression algorithm may be used recursively to reduce the size of the file by using the same or different hash functions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system for file compression and decompression.

FIG. 2 is a flowchart illustration of an embodiment showing a method for compressing a file.

FIG. 3 is a flowchart illustration of an embodiment showing a method for decompressing a file.

### DETAILED DESCRIPTION

A compression algorithm may use one or more hash functions to recursively compress a file. The hash values and indexes for collisions may be stored in a compressed file. The file may be uncompressed by determining the original input to the hash function and recreating the original file.

The compression algorithm may be recursively performed, enabling a file to be compressed multiple times.

The hash algorithm may be any type of formula or mechanism that may determine a hash value for a portion of the file. In one mechanism for determining a hash value, a database of input values and hash values may be used. Some embodiments may use the database as a shared secret between a sending and receiving device. In another mechanism, a hash value may be computed using a predefined algorithm. During the decompression process, the input value of the hash function may be calculated using the algorithm.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

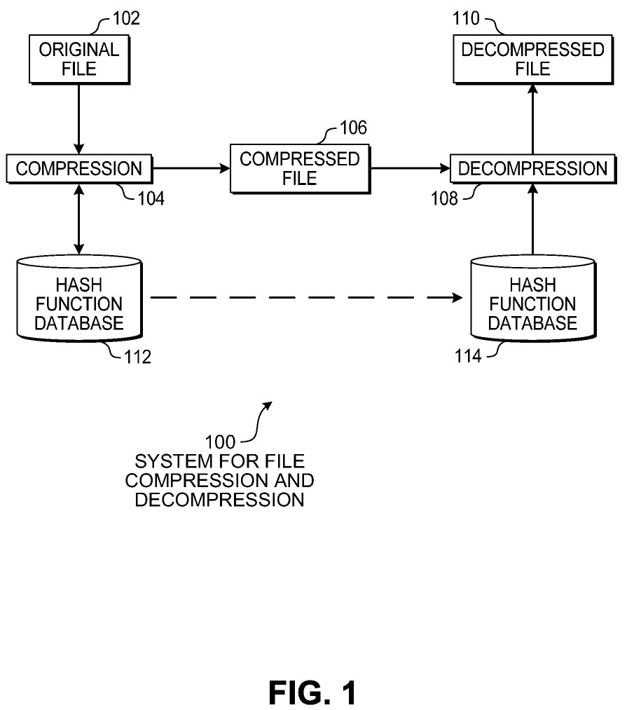

FIG. 1 is a diagram of an embodiment 100 showing a system that may compress and decompress files. Embodiment 100 is a simplified example of the various components that may be used for compression and decompression.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 illustrates an original file 102 that may be compressed by a compression mechanism 104 to generate a compressed file 106. The compressed file 106 may be decompressed by a decompression mechanism 108 to produce a decompressed file 110. The decompressed file 110 may be identical to the compressed file 102.

The compressed file 106 may be used for many different purposes. In many uses, the compressed file 106 may be stored or transmitted. The compressed file 106 may be substantially reduced in size from the original file 102 and thus the compressed file 106 may take up less storage space and be less costly to transmit. In many uses, the compression mechanism 104 may create a compressed file 106 that may be difficult to read. In some embodiments, the compressed file 106 may be encrypted using the compression mechanism 104.

The compression mechanism 104 may compress the original file 102 using a hash function. The hash function may be any mechanism that may generate a hash value for a given portion of the original file 102. In many embodiments, the hash value may be calculated using a function that may produce a hash value. In other embodiments, the hash value may be determined by looking up a hash value from a hash function database 112. In some embodiments, the hash value may be determined by performing a combination of computational functions and looking up values from a predetermined database.

The hash value may be a value that represents the uncompressed portion of the file, but may do so in less space than the original, uncompressed portion of the file. The original, uncompressed portion of the file may be re-created by performing the hash computation in reverse, or by looking up the original value in a database.

When a hash function results in the same hash value for two different inputs, the hash function is said to have a collision. When a collision occurs in the compression mechanism 104, an index may be assigned to indicate to which of the different inputs the hash value refers.

The compression mechanism 104 may use any hash function, including hash functions designed to have multiple collisions as well as those hash functions for which few, if any, collisions exist. Examples hash functions for which very few collisions exist are hash functions often used in cryptography, such as SHA-0, SHA-1, MD4, MD5, RIPEMD, and others.

Cryptographic hash functions are typically very difficult to process in reverse. In such a case, the hash function database 112 may be used to store the hash values and the input string used to calculate the hash value. The hash function database 112 may be shared between the compression mechanism 104 and the decompression mechanism 108.

In some cases, a hash function may be calculated in reverse. Examples of such functions may include cyclic redundancy check (CRC) and other similar checksum algorithms. Such functions may have multiple collisions.

Some embodiments may use a hash function database 112 that may exist prior to operating the compression mechanism 104. The hash function database 112 may be fully populated or partially populated. In some cases, the hash function database 112 may be shared between the compression mechanism 104 and the decompression mechanism 108.

In many embodiments, the compression mechanism 104 may exist on one device and the decompression mechanism 108 may exist on a second device. In a typical use, one device may operate a compression mechanism 104 to produce a compressed file 106. The compressed file 106 may be transmitted to another device that may operate a decompression mechanism 108. The compressed file 106 may be transmitted using any type of communications network including local area networks, wide area networks, wired networks, wireless networks, and networks using various protocols and transmission mechanisms. In some uses, the compressed file 106 may be transmitted by physically transporting a storage medium on which the compressed file 106 may be stored.

In an embodiment where the compression mechanism 104 and decompression mechanism 108 are located on different devices, the hash function database 112 may be shared between the two devices. In embodiments where the hash function database 112 is a fully populated database, the hash function database 112 may be distributed to each of the devices prior to compressing the original file 102 or decompressing the compressed file 106. In some embodiments, the hash function may be distributed from which each device may calculate a fully populated hash function database 112.

The compressed file 106 may be created by analyzing a portion of the original file 102, determine a hash value for the portion, and storing the hash value in the compressed file 106. When the hash function contains collisions, the compressed file 106 may also contain indexes that identify which of the input values the hash value represents. In embodiments where the hash function does not contain collisions, the compressed filed 106 may contain only hash values.

Some embodiments may perform a hash function on a fixed portion of the original file 102. For example, a hash function may analyze each 32 bit portion of data and generate an 8 bit hash with an 8 bit index. Other embodiments may analyze each 512 bit block and produce a 32 bit hash value.

Other embodiments may perform a hash function on variably sized file portions. For example, a text file may be analyzed by calculating a hash value for each word in the text of the file. Some words may be longer than others and thus the portion of the file that is analyzed may vary in size. Some files may have periodic delimiters that may be used to identify different portions of the file.

Many embodiments may compress the original file 102 by recursively applying a compression mechanism using hashes. In each pass of the file, a portion of the file may be analyzed, a hash value determined, and the hash value placed in the compressed file. By repeating the process, the compressed file may be compressed again and again, yielding a much smaller sized file than if the compression algorithm were performed one time.

In some embodiments, the same hash function may be applied in succession. In other embodiments, different hash functions may be used in each pass of the file.

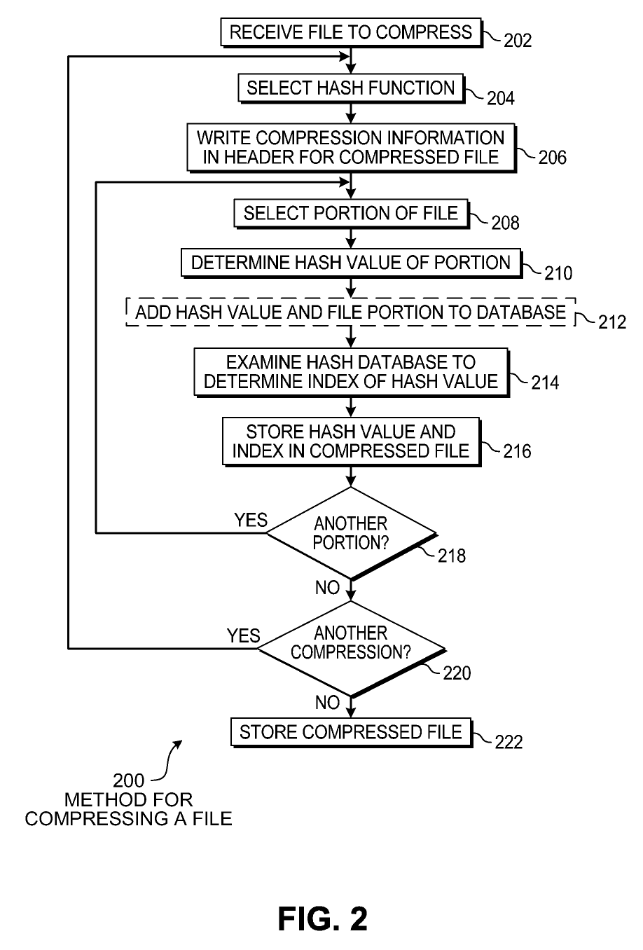

FIG. 2 is a flowchart illustration of an embodiment 200 showing a method for compressing a file. Embodiment 200 is a simplified example of a sequence for compressing a file using a hash function.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 is an example of a compression mechanism that sequentially analyzes a file to compress. Sequential portions of the file may be analyzed by determining a hash value for the portion and storing the hash value in a compressed file. In some embodiments, the compressed file may be further compressed by applying the same basic process. When two or more passes of the files are performed, the same or different hash functions may be applied.

A file to be compressed may be received in block 202. The file to be compressed may be any type of file, including files containing data and executable files.

A hash function may be selected in block 204. In some embodiments, different hash functions may be selected for different types of files. Some embodiments may also use different hash functions for each successive compression of a file.

The hash function selected in block 204 may be any type of hash function. In broad categories, the hash function may be a calculated function or may be a function that uses a lookup operation in a database. Some embodiments may use elements of both categories of functions.

In many embodiments, a hash function may be an algorithm or other function that may be calculated. In such embodiments, a hash value may be calculated using a hash function of various complexities. Some hash functions, such as cyclic redundancy check (CRC) functions, may be readily calculated. Some hash functions used for encryption, such as MD5, SHA-1, SHA-2, and others may be calculated with a known but complex algorithm.

In some embodiments, the hash function may comprise a lookup operation in a hash function database. In such an embodiment, a hash value may be determined by querying a database with the file portion to return a hash value.

In some embodiments, an intermediate hash value may be determined by calculation, and the intermediate hash value may be looked up in a database to return a compressed hash value.

After selecting the hash function in block 204, some compression information may be written into a header for the compressed file in block 206. The header may include sufficient information so that a decompression mechanism may be able to determine the proper hash algorithm and other characteristics about a compressed file.

A portion of the file may be selected in block 208. In some embodiments, the portion selected in block 208 may be a constant size for each block. In other embodiments, the portion selected in block 208 may vary from one portion to another. In such an embodiment, the contents of the file may be analyzed to determine a portion size. For example, a data file that contains delimiters between each data record may be analyzed by selecting the file portion between the delimiters.

After selecting a portion of the file in block 208, a hash value may be determined in block 210. The hash value may be determined by calculation using an algorithm or formula, or may be determined in whole or in part by looking up a hash value from a hash data file.

In many embodiments, a hash database may be used to store the hash value and a file portion. A hash database may be used when the function selected in block 204 is difficult to calculate the file portion from the hash value. A hash database may also be used when the hash function has collisions.

In some embodiments, the hash value and file portion may be added to the hash database in block 212. The hash value and file portion may be added to the hash database when the hash value and file portion are not already stored in the hash database.

Some embodiments may use a fully populated hash database. In such an embodiment, every input combination of a file portion and corresponding hash value may be present. Such an embodiment may be useful when the file portion sizes are relatively small, such as 8 bytes or less.

Some embodiments may use a partially populated hash database. In such an embodiment, the hash database may be reused and expanded each time a file is compressed. As the hash values are calculated for a file portion, the file portion and hash values may be added to the database if the values are not already present in block 212.

In embodiments where a hash collision occurs, the hash database may be examined in block 214 to determine an index of the hash value. The index may refer to which input value corresponds to the file portion of block 208.

The hash value and index may be stored in the compressed file in block 216.

If another file portion has not been analyzed in block 218, the process may return to block 208. If no other file portions are available in block 218, a complete pass has been made of the original file. In block 220, another compression pass may be performed by returning to block 204 and compressing the compressed file even further.

If no other compression passes are performed in block 220, the compressed file may be stored in block 222.

In many embodiments, a file may be compressed two, three, or even more times by repeating the compression process. Such embodiments may be particularly effective when a hash database is used, as the compressed file size may be reduced considerably. In such embodiments, the hash database may be shared between the compression mechanism and the decompression mechanism. In many cases, the hash database may be used for compressing and decompressing many different files.

In cases where the hash database is relatively small, the compressed file in block 222 may include the hash database. In such a case, the compressed file in block 222 may include all the information that may be used to decompress the file. In cases where the compressed file in block 222 does not include the hash database, any decompression mechanism may use a separate hash database or may be able to calculate the file portion from the hash value.

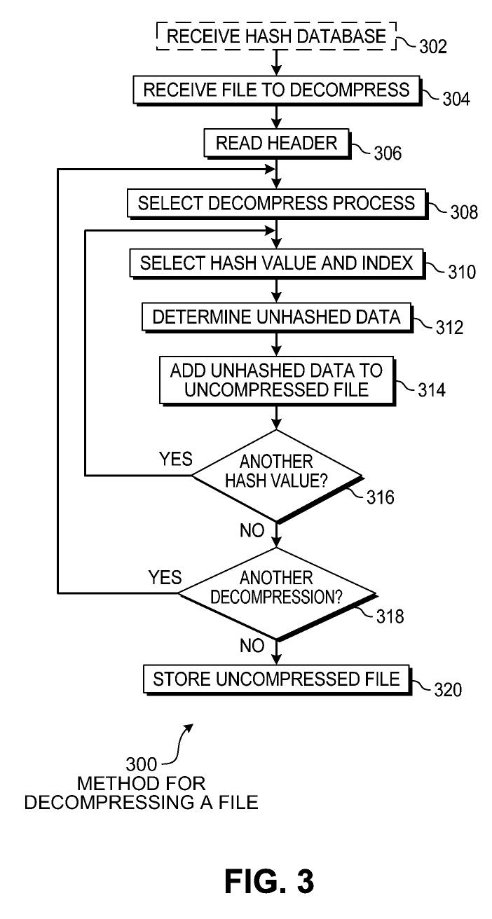

FIG. 3 is a flowchart illustration of an embodiment 300 showing a method for decompressing a file. Embodiment 300 is a simplified example of a sequence for decompressing a file that was compressed using the method of embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The decompression method of embodiment 300 may mirror the compression method of embodiment 200. The same number of passes may be made through the file, and in each pass, the file portion may be determined from the hash value in the file. In some embodiments, the file portion may be determined by calculating the inverse hash function. In other embodiments, the file portion may be determined by looking up the hash value in a hash database.

In some embodiments, a hash database may be transferred or obtained by the decompression mechanism separately from the compressed file in block 302. An example may include embodiments where a fully populated hash database may be used. In such an example, the fully populated hash database may be used for decompressing many different compressed files and thus may be used over and over.

Some embodiments may be able to create a fully populated hash database on a device that performs the decompression method of embodiment 300. In such an embodiment, an executable program may be able to calculate each record in the hash database prior to decompressing a file.

In some embodiments, the hash database obtained in block 302 may be a partially populated hash database.

In some embodiments, the hash database obtained in block 302 may be a shared secret. In such an embodiment, those devices that are authorized or permitted to view the uncompressed file may receive the hash database.

The file to decompress may be received in block 304. In some embodiments, the file to decompress may include the hash database of block 302.

The header of the compressed file may be read in block 306. The header may include information about the compression method, including which hash functions were used, the number of recursive compression that were applied, and other information. Such header information may be used by a decompression mechanism to decompress the file.

The decompression process may be selected in block 308. The decompression process selected in block 308 may be based on the header information read in block 306 and may define the hash function, file portion size, and other variables that may be used for the first decompression pass.

The hash value and index may be selected in block 310 from the compressed file and the unhashed data or file portion may be determined in block 312.

In some embodiments, the unhashed data or file portion that was used to create the hash value may be determined in block 312 by calculating the inverse hash function. Some embodiments may have specialized processors that may enable rapid calculation of such functions. Other embodiments may use the hash database to look up the hash value and determine the original file portion. In cases where collisions occur with the hash function, an index from the compressed file may be used to indicate one of the collided input values.

After determining the unhashed value in block 312, the value is added to an uncompressed filed in block 314. If another hash value has not been processed in block 316, the process may continue in block 310. If a second decompression is to be performed in block 318, the process may continue in block 308.

After all the hashes in the compressed file have been processed, and each pass through the compressed file has been completed, the uncompressed file may be stored in block 320.

In many embodiments, the uncompressed file in block 320 may be exactly the same file as received in block 202 of embodiment 200.

The following is an example of a hash function that may be used recursively to compress a file. The hash function analyzes 32 bit block of data, and the hash value is the number of bits that are ‘1’ minus 2. If the value is −1 or −2, the hash value is set to 0. The hash value is 5 bits and the index is 11 bits. This hash function compresses an arbitrary 32 bit block into a 16 bit hash value/index representation.

An example of a partially filled in binary database may as follows in Table 1.

TABLE 1

| | | Index (Binary) |
|---|---|---|
| Value | Hash | (Decimal) |
| 00000000000000000000000000000000 = | 00000 | 00000000000 |
| | | (Index 1) |
| 00000000000000000000000000000001 = | 00000 | 00000000001 |
| | | (Index 2) |
| 00000000000000000000000000000010 = | 00000 | 00000000010 |
| | | (Index 3) |
| 00000000000000000000000000000100 = | 00000 | 00000000011 |
| | | (Index 4) |
| (Etc. . . . ) | | |
| 10000000000000000000000000000000 = | 00000 | 00000100000 |
| | | (Index 33) |
| 00000000000000000000000000000011 = | 00000 | 00000100001 |
| | | (Index 34) |
| 00000000000000000000000000000101 = | 00000 | 00000100010 |
| | | (Index 35) |
| 00000000000000000000000000001001 = | 00000 | 00000100011 |
| | | (Index 36) |
| (Etc. . . . ) | | |
| 11000000000000000000000000000000 = | 00000 | 10000000011 |
| | | (Index 1028) |
| 00000000000000000000000000000111 = | 00001 | 00000000000 |
| | | (Index 1) |
| 00000000000000000000000000001011 = | 00001 | 00000000001 |
| | | (Index 2) |
| 00000000000000000000000000010011 = | 00001 | 00000000010 |
| | | (Index 3) |
| (Etc. . . . ) | | |
| 00111111111111111111111111111111 = | 11100 | 00000000000 |
| | | (Index 1) |
| (Etc. . . . ) | | |
| 11111111111111111111111111111100 = | 11100 | 01111011111 |
| | | (Index 992) |
| 01111111111111111111111111111111 = | 11101 | 00000000000 |
| | | (Index 1) |
| (Etc. . . . ) | | |
| 11111111111111111111111111111110 = | 11101 | 00000011111 |
| | | (Index 32) |
| 11111111111111111111111111111111 = | 11110 | 00000000000 |
| | | (Index 1) |

The compressed data file may include an indicator prior to a hash and index that indicates whether the following data are raw data or a hash and index pair. The indicator may be set to 0 for a compressed hash and index pair or the indicator may be set to 1 for an uncompressed block of data. Some data may not be compressed when the index is larger than 11 bits, for example.

A raw, uncompressed set of a data may be illustrated in Table 2. The data is broken into 32 bit blocks.

TABLE 2

| | |
|---|---|
| 00000000000000000000000000000010 | 00111111111111111111111111111111 |
| 00000000000000000000000000001001 | 10101110101101111111111111111111 |
| 11111111111111111111111111111100 | 00000000000000000000000000000111 |
| 11000111110111111111111111111111 | 00000000000000000000000000000111 |
| 00000000000000000000000000000000 | 11111111111111111111111111111111 |

The compressed data may be represented in Table 3, along with notation for each element of the compressed data.

TABLE 3

| Hash #2 | C | Hash | Index | C | Hash | Index | C | Hash | Index |
|---|---|---|---|---|---|---|---|---|---|
| 00000010 | 0 | 00000 | 00000000010 | 0 | 11100 | 00000000000 | 0 | 00000 | 00000100011 |

| | | | | |
|---|---|---|---|---|
| N | Uncompressed Data | C | Hash | Index |
| 1 | 10101110101101111111111111111111 | 0 | 11100 | 01111011111 |

| C | Hash | Index | N | Uncompressed Data | | | | |
|---|---|---|---|---|---|---|---|---|
| 0 | 00001 | 00000000000 | 1 | 11000111110111111111111111111111 | | | | |
| C | Hash | Index | C | Hash | Index | C | Hash | Index |
| 0 | 00001 | 00000000000 | 0 | 00000 | 00000000000 | 0 | 11110 | 00000000000 |

The compressed data without notation is illustrated in Table 4. The data or Table 4 are illustrated in 32 bit blocks.

| | |
|---|---|
| 00000010000000000000000100111000 | 00000000000000000000010001111010 |
| 11101011011111111111111111110111 | 00011110111110000010000000000011 |
| 10001111101111111111111111111110 | 00001000000000000000000000000000 |
| 001111000000000000 | |

The example illustrates a hash/index combination that may be used in a recursive compression method.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method for compressing a file, said method comprising:
receiving said file to compress;
separating said file into a first plurality of portions;
for each of said portions in said first plurality of portions:
determining a first hash value for said portion using a first hash function;
determining a first index of said first hash value for said portion; and
storing said first hash value and said first index into a first compressed file.

2. The method of claim 1 further comprising:
separating said first compressed file into a second plurality of portions;
for each of said portions in said second plurality of portions:
determining a second hash value for said portion using a second hash function;
determining a second index of said second hash value for said portion; and
storing said second hash value and said second index into a second compressed file.

3. The method of claim 2, said storing said first hash value comprising storing said portion in a first database.

4. The method of claim 3, said first database being separate from said first compressed file.

5. The method of claim 3, said first database being incorporated into said first compressed file.

6. The method of claim 2, said determining a first hash value comprising looking up said portion in a database to determine said first hash value.

7. The method of claim 6, said database being a fully populated database.

8. The method of claim 6, said database being a non-fully populated database.

9. The method of claim 8, said storing said first hash value comprising storing said portion and said first hash value in said database.

10. The method of claim 2, said first hash function and said second hash function being different hash functions.

11. The method of claim 2, said portions being unequal portions.

12. The method of claim 2, said first hash function being a cyclic redundancy check function.

13. A method for uncompressing a file, said method comprising:
receiving said file to decompress;
examining a header to determine compression information;
identifying a plurality of hash values in said file;
for each of said hash values:
determining an inverse of said hash value to determine a file portion based on said hash values, said hash value being determined by a first hash function;
storing said file portion in a first uncompressed file.

14. The method of claim 13 further comprising:
identifying a second plurality of hash values in said first uncompressed file;
for each of said hash values:
determining an inverse of said hash value to determine a file portion based on said hash values, said hash value being determined by a second hash function;
storing said file portion in a second uncompressed file.

15. The method of claim 14, said first hash function being the same as said second hash function.

16. The method of claim 14, said first hash function being different from said second hash function.

17. The method of claim 14, said determining an inverse of said hash value comprising looking up said hash value in a database.

18. The method of claim 15, said database being a shared secret database.

19. A compressed file created by a method comprising:
receiving said file to compress;
separating said file into a first plurality of portions;
for each of said portions in said first plurality of portions:
determining a first hash value for said portion using a first hash function;
determining a first index of said first hash value for said portion; and
storing said first hash value and said first index into a first compressed file;
separating said first compressed file into a second plurality of portions;
for each of said portions in said second plurality of portions:
determining a second hash value for said portion using a second hash function;
determining a second index of said second hash value for said portion; and
storing said second hash value and said second index into said compressed file.

20. The compressed file of claim 19 further comprising a database comprising said portions and said first hash value.
